(19) United States
(12) Patent Application Publication
(10) Pub. No.: US 2013/0126172 A1
(43) Pub. Date: May 23, 2013

(54) METHOD OF MAKING CARBON DIOXIDE

(71) Applicant: ENERJETIC LLC, Denver, CO (US)

(72) Inventors: James E. Klepper, Thornton, CO (US); Kenneth L. Klepper, Arvada, CO (US)

(73) Assignee: ENERJETIC LLC, Denver, CO (US)

(21) Appl. No.: 13/681,593

(22) Filed: Nov. 20, 2012

Related U.S. Application Data
(60) Provisional application No. 61/562,791, filed on Nov. 22, 2011.

(51) Int. Cl. C01B 31/20; E21B 43/16

(52) U.S. Cl. CPC C01B 31/20; E21B 43/164
USPC 166/305.1; 423/437.1

(57) ABSTRACT

Carbon dioxide free of many impurities is formed by combusting syngas with oxygen and controlling the amount of oxygen combined with the syngas so that the produced combustion gas has less than 2% unreacted oxygen. The syngas can be formed in a horizontal reactor 10 which combusts fuel with oxygen in the presence of water to form a hot gas stream which contacts a carbon feed stock introduced into a reaction zone 23 to form syngas. This is collected in a residence chamber 18, which has a gas outlet 20 leading directly to the syngas burner 75 located in the combustion chamber 71.

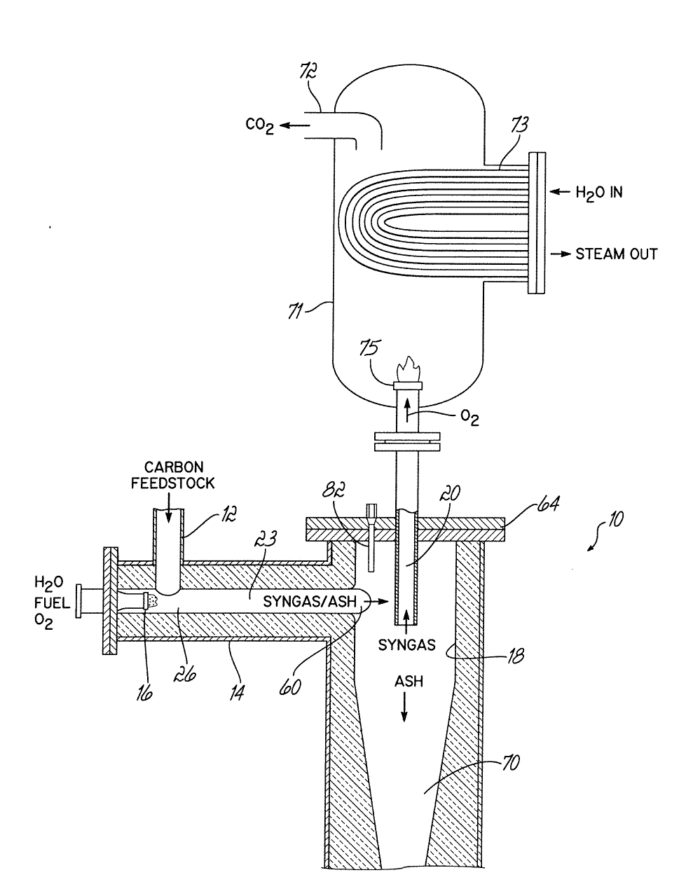

### BACKGROUND OF THE INVENTION

High purity carbon dioxide can be used for a wide variety of different applications. But, obtaining the carbon dioxide by combustion typically does not produce carbon dioxide having a purity suitable for many of these applications.

Carbon dioxide can be used for extracting oil from an oil well. It is injected into the oil well to displace the oil, increasing production. To be effective, it should be relatively pure carbon dioxide, free of nitrogen.

Carbon dioxide can be formed in a variety of different manners. If formed from combustion products using air, the carbon dioxide must be purified. The purification must be done in a factory, and the carbon dioxide, in turn, shipped to the site for use. This is relatively expensive and inefficient. Even when, for example, methane is combusted with oxygen, unwanted by products can be formed.

### SUMMARY OF THE INVENTION

The present invention provides a method to produce carbon dioxide directly from syngas, while at the same time utilizing the generated heat to produce power.

The present invention is premised on the realization that carbon dioxide can be produced directly from syngas which can be produced on site, combusting this with substantially pure oxygen to product carbon dioxide and water, which can be stripped. This leaves relatively pure carbon dioxide substantially free of nitrogen. This can be cooled and directly injected into either a gas well or an oil well to enhance oil or gas production.

By monitoring oxygen in the final combustion product, the oxygen input can be controlled to avoid unwanted by products. Specifically, the oxygen in the combustion gas should be less than 2%. The formed gas is over 60% CO₂ with less than 15% N², generally less than 10% N².

The objects and advantages of the present invention will be further appreciated in light of the following detailed description and drawing in which:

### BRIEF DESCRIPTION OF THE DRAWING

The FIGURE is a diagrammatic cross sectional view of an apparatus for use in producing carbon dioxide from syngas.

### DETAILED DESCRIPTION

Syngas is a combustible gas which is formed by combusting a carbon source with a sub-stoichiometric amount of oxygen in the presence of steam to produce, in turn, a combination of carbon monoxide and hydrogen, both of which are combustible. It can be produced by a variety of different apparatus, in particular, the apparatus, disclosed in U.S. Pat. No. 6,863,878, as well as that disclosed in PCT application WO 2010/127062 A1, the disclosures of which are hereby incorporated by reference.

As shown in the FIGURE, a syngas reactor 10, which is similar to the reactor disclosed in WO 2010/127062 A1, includes a feed inlet 12 which leads to a horizontal reactor 14 having a combustion nozzle 16. Nozzle 16 is adapted to heat carbon feed introduced into the horizontal reactor 14. Horizontal reactor 14, in turn, leads to a cylindrical residence chamber 18 which has a gas outlet 20.

The horizontal reactor 14 as shown includes a steel casing and a refractory liner which defines a tubular horizontal reaction area 23. The carbonaceous feed passes through inlet 12 into reaction area 23 immediately downstream from a combustion zone 26 immediately forward of combustion nozzle 16. The width and length of reaction are determined by feed rate and the capacity to generate the requisite heat.

A second end 60 of the horizontal reaction area 23 leads into the resonance chamber 18. As shown, the reaction area 23 is aligned along a tangent with the cylindrical resonance chamber 18. The resonance chamber 18 has a cylindrical wall and a closed top 64. The wall has a steel casing and a refractory lining. A gas outlet 20 extends through the top 64 into the resonance chamber 18 slightly below the inlet 60 from the horizontal reaction area 23. Also extending through the closed top 64 is a test port inlet 82.

The resonance chamber 18, in turn, has a bottom end which is in communication with a frustoconical section 70. Again, this section 70 has a steel casing and a refractory lining. Section 70 has a tapered side wall and a narrowed bottom outlet which is in communication with a recovery tank partially filled with water (not shown).

Gas outlet 20 extends to a nozzle 75 having an oxygen inlet and located in a combustion chamber 71. The combustion chamber 71, in turn, has an exhaust outlet 72. Coils 73 extend into the combustion chamber 71.

The feed material for the reactor 10 can be any carbonaceous material. It can be formed from organic material, polymeric material such as ground tire, wood, coal, and the like. The carbon source can be natural gas, methane or propane as well. Preferably, the feed will be a devolatilized carbon source in which reactive oxygen has been eliminated, as well as other organic components using a devolatilization reactor, such as that disclosed in U.S. Pat. No. 6,863,878, the disclosure of which is hereby incorporated by reference. This is upstream of apparatus 10 and not shown in the drawings.

Syngas or other fuel such as propane or natural gas, is introduced through the nozzle 16 and, at the same time, oxygen is added so that stoichiometric combustion occurs at the combustion chamber. The oxygen is relatively pure, preferably at least 90% pure, preferably 95% pure and generally 98% pure or better. Nitrogen content should be minimized, generally 3% or less. This combustion will generate the heat necessary to cause the substoichiometric reaction of the carbon with steam and any additional oxygen as necessary to form syngas. The burner temperature should be at least 1300° F., more typically 2300° F.

In operation, feed material introduced into apparatus 10 will pass through inlet 12 and pass into the reaction area 23 immediately downstream from the combustion nozzle 16. The intersection of the vertical and horizontal feed conveyor provides a seal, preventing gas from flowing out the feed inlet.

As the oxygen and fuel are introduced into the burner nozzle 16, a blend of oxygen and water or steam is introduced also at nozzle 16, but slightly downstream of the initial combustion area. The heat from the combustion raises the temperature of the water/steam enabling it to react with carbon in the reaction area 23. The added oxygen increases the temperature of the gas stream during the reducing reaction immediately downstream of the stoichiometric combustion in the combustion chamber. The added oxygen also promotes formation of carbon monoxide. Generally, the additional oxygen will be very minor, less than 1% of the water by weight. The steam swirls around, combines with the combustion products from the stoichiometric combustion and contacts the carbon source introduced through inlet 12.

It is desirable to have the temperature in the horizontal reaction chamber 23 to be at least about 1200° F., and generally 2300° F., or more. At 2300° F., any ash that remains from the char will be melted.

The pressure in the reaction zone can be from atmospheric up to 1000 psig. Pressure is not a determining factor in the reaction, but is incidental to reaction conditions.

The combustion at nozzle 16 creates a high velocity gas stream that will pass through the reaction chamber into the resonance chamber 18. Chamber 18, also maintained at at least 1000° F., provides sufficient time for complete reaction. Generally, the gas will be in the reaction area 23 from about 0.1 to 0.3 seconds, with the velocity of the gas passing through the chamber about 500 to about 3000 ft/sec.

The horizontal reaction area 23 is linear and its second end 60 is aligned tangentially with the cylindrical wall 62 of the residence chamber 18 causing a swirling movement of the gas around the wall 62 of the residence chamber 18. As the reaction continues, gas is forced downwardly, and the syngas will be collected from outlet tube 20.

The syngas from outlet tube 20 passes through nozzle 75 and is combined with additional relatively pure oxygen, and ignited. The amount of oxygen must be controlled so that excess oxygen is not present. By monitoring the combustion output gases, one can determine if excess oxygen is present. Generally, there should be less than about 2%, preferably less than 1%, and more particularly less than 0.5% of oxygen measured as argon/oxygen in the combustion product. If excess oxygen is present, additional unreacted side products will form and relatively pure carbon dioxide will not be obtained. This combustion will create heat and primarily carbon dioxide and water.

Water can be forced through the coils 73 and be heated to form steam. The steam can then be used for power generation, or the like, and can be used in the syngas reaction. The formed carbon dioxide will pass through outlet 72 and be stripped of water and collected. The combustion gas will be a relatively high purity carbon dioxide. An exemplary product is shown in the Table. This was produced from coal as the carbon source. The nitrogen came from the coal. Thus, by using a different carbon source, the nitrogen level can be reduced. Also, the CO₂ level is higher than reported due to limitations of the gas chromatograph used to measure the gas components.

The goal is 60% to 90% CO₂ and less than 5% nitrogen, preferably 70% to 90% CO₂ and 10% nitrogen or less.

TABLE

| # | Peak Name | Channel | RT | Result | Area |
|---|---|---|---|---|---|
| 1 | Helium | Channel 1 - CP | 0.0000 | 0.0000 | 0 |
| 2 | Hydrogen | Channel 1 - CP | 1.3487 | 5.1812 | 68131 |
| 3 | Argon/02 | Channel 2 - CP | 1.6232 | 1.5776 | 17733 |
| 4 | Nitrogen | Channel 2 - CP | 2.2830 | 9.7228 | 90245 |
| 5 | Methane | Channel 2 - CP | 3.787 | 0.1245 | 1102 |
| 6 | Carbon Monoxide | Channel 2 - CP | 5.2925 | 1.9903 | 23824 |
| 7 | Carbon Dioxide | Channel 3 - CP | 0.8675 | 70.7525 | 2073285 |
| 8 | Ethylene | Channel 3 - CP | 1.0207 | 0.0577 | 1480 |
| 9 | Ethane | Channel 3 - CP | 0.0000 | 0.0000 | 0 |
| 10 | Propane/Propylene | Channel 4 - CO | 0.6755 | 0.0000 | 5151 |
| 11 | DME | Channel 4 - CO | 0.0000 | 0.0000 | 0 |
| 12 | Methanol/i-Butane | Channel 4 - CO | 0.0000 | 0.0000 | 0 |
| 13 | n-Butane | Channel 4 - CO | 0.0000 | 0.0000 | 0 |
| 14 | Ethanol | Channel 4 - CO | 0.0000 | 0.0000 | 0 |
| 15 | i-Pentane | Channel 4 - CO | 0.0000 | 0.0000 | 0 |
| 16 | n-Pentane | Channel 4 - CO | 0.0000 | 0.0000 | 0 |
| 17 | l-Propanol | Channel 4 - CO | 0.0000 | 0.0000 | 0 |
| 18 | n-Hexane | Channel 4 - CO | 0.0000 | 0.0000 | 0 |
| 19 | Benzene | Channel 4 - CO | 0.0000 | 0.0000 | 0 |
| 20 | n-Heptane | Channel 4 - CO | 0.0000 | 0.0000 | 0 |
| | Totals | | | 90.0656 | 2280951 |

Because the syngas is formed from devolatilized feedstock and subsequently burned in oxygen, the formed carbon dioxide has minimal nitrogen, making it particularly suitable for extraction of oil from oil wells. This can be directly injected into a gas or oil well to increase production. Alternatively, it can be stored and used in any application which requires relatively pure carbon dioxide.

Although the present invention discloses formation of syngas in situ, it can be formed separately and combusted with oxygen according to the present invention.

This has been a description of the present invention along with the preferred method of practicing the present invention. However, the invention itself should only be defined by the appended claims, WHEREIN WE CLAIM:

What is claimed is:

1. A method of forming carbon dioxide comprising:
establishing a flowing stream of hot gas by combusting a fuel at an inlet nozzle;
combining combustion products at said combustion nozzle with steam;
adding a carbon source to said stream of hot gas at a temperature effective to form combustion gas comprising syngas;
combusting said syngas in a second combustion chamber with added oxygen to form combustion gas comprising carbon dioxide; and
collecting said carbon dioxide.

2. The method claimed in claim 1 wherein an amount of said added oxygen is established so that less than 2% oxygen is present in said combustion gas.

3. The method claimed in claim 2 wherein said oxygen is at least 97% pure.

4. The method claimed in claim 3 wherein said combustion gas comprises at least 60% carbon dioxide and less than 15% nitrogen.

5. The method claimed in claim 1 wherein said carbon source comprises coal.

6. The method claimed in claim 1 wherein said carbon source is natural gas.

7. The method claimed in claim 1 wherein said carbon dioxide is injected into an oil or gas well.

8. A method of forming carbon dioxide comprising combusting syngas with an amount of oxygen to form a combustion gas comprising carbon dioxide and establishing said amount of oxygen whereby said combustion gas includes less than 2% oxygen.
